(19) United States
(12) Patent Application Publication
(10) Pub. No.: US 2026/0321470 A1
(43) Pub. Date: Oct. 15, 2026

(54) FERROMAGNETIC POWDER COMPOSITION AND METHOD FOR PRODUCING THE SAME

(71) Applicant: HÖGANÄS AB (Publ), Höganäs (SE)

(72) Inventors: Björn SKÅRMAN, Höganäs (SE); Zhou YE, Lerberget (SE); Christian JÖNSSON, Malmö (SE)

(73) Assignee: HÖGANÄS AB (Publ), Höganäs (SE)

(21) Appl. No.: 19/104,136

(22) PCT Filed: Aug. 15, 2023
(86) PCT No.: PCT/EP2023/072456

§ 371 Date: Feb. 14, 2025

(30) Foreign Application Priority Data
Aug. 24, 2022 (EP) 22191925.1

(51) Int. Cl. H01F 1/24; B22F 1/102; B22F 1/16; H01F 3/08; H01F 41/02

(52) U.S. Cl. CPC H01F 1/24; B22F 1/102; B22F 1/16; H01F 3/08; H01F 41/0246; B22F 2301/35

(57) ABSTRACT

A ferromagnetic powder composition including (i) soft magnetic iron-based core particles, and (ii) a first coating at least partially covering and being in direct contact with the surface of the core particles. The first coating includes a) a silicate of the general formula (K₂O)α(SiO₂)β, wherein α is moles of K₂O, β is moles of SiO₂, and the β/α molar ratio is in the interval from 0.5 to 4.1, wherein the silicate is present in an amount of 0.02 to 1.0 wt % calculated based on the total weight of the ferromagnetic powder composition, b) particles of a compound including bismuth and oxygen having a D₅₀ in the interval of 0.1 to 10 μm, and c) nanoparticles having a D₅₀ of 10-200 nm. Methods of producing a ferromagnetic powder composition and manufacturing an object from the ferromagnetic powder composition and objects obtained by the methods or including a compacted ferromagnetic powder composition.

### TECHNICAL FIELD

The technology proposed herein relates generally to the field of ferromagnetic powder compositions comprising soft magnetic iron-based core particles and methods for producing ferromagnetic powder compositions.

### BACKGROUND

Ferromagnetic powders include soft magnetic composite (SMC) powders which comprise soft magnetic core particles, usually iron-based, with an electrically insulating coating on each particle. Such powders may be used to obtain soft magnetic components or parts, such as by compacting the powders into the desired shape. These components or parts, also known as soft magnetic composites, may be used as an alternative to laminated steel components in electric motors, generators, electromagnets in a wide range of applications.

Two key characteristics of a soft magnetic core particle and a corresponding component made from such particles, are magnetic permeability μ and core loss characteristics P_{c}. The magnetic permeability μ of a material is an indication of its ability to become magnetized or its ability to carry a magnetic flux. Maximum permeability (μₘₐₓ) is defined as the highest value of B/H, i.e. the ratio of the magnetizing force B or field intensity to the induced magnetic flux H. When a magnetic material is exposed to a varying field, energy losses occur due to both hysteresis losses and eddy current losses. The hysteresis loss (DC-loss), which constitutes the majority of the total core losses in most motor applications, is brought about by the necessary expenditure of energy to overcome the retained magnetic forces within the part made from the soft magnetic core particles and is influenced by the retentivity, or remanence B_{R}, and the coercivity H_{C}.

The retained magnetic forces within the component may be minimized by increasing the quality and purity of the soft magnetic core particles and, in particular, by heat treating the component so as to cause a release of stress caused by the compaction shear forces within the component. Energy losses are further caused by Eddy current loss (AC-loss) which is caused by the induction of electric currents in the part due to the changing flux caused by alternating current (AC) conditions. The Eddy current loss is minimized by the electrically isolating coating on each particle which thereby isolates the soft magnetic core particles from each other. Accordingly, the resistivity R of the coating becomes an important parameter for defining the characteristics and useability of the soft magnetic core particles. The level of electrical resistivity R that is required to minimize the AC losses in a part made from soft magnetic core particles is dependent on the size distribution of the soft magnetic core particles, the size of the part, and the frequency of the alternating magnetic field in which the part is to be used.

EP 2 252 419 B1 generally discloses a ferromagnetic powder composition comprising soft magnetic iron-based core particles, wherein the surface of the core particles is provided with a first inorganic insulating layer and at least one metal-organic layer, located outside the first layer.

U.S. Pat. No. 10,741,316 generally discloses a ferromagnetic powder composition including soft magnetic iron-based core particles, wherein the surface of the core particles is coated with at least one phosphorus-based inorganic insulating layer and then at least partially covered with metal-organic compound(s).

EP 3 411 169 B1 generally discloses a powder mixture comprising phosphorous coated iron alloy particles and phosphorous coated iron particles.

WO 2020/252551 generally concerns a particulate material comprising ferromagnetic particles covered by at least one oxide layer consisting of nanoparticles and at least one glassy layer covering the oxide layer.

Despite the advantages brought about by the technology described in the above cited prior art documents, there remains a need to provide ferromagnetic powder compositions comprising soft magnetic core particles having improved electrical, magnetic, and structural properties.

### Objects

A primary object of the technology proposed herein is to provide ferromagnetic powder compositions and mixtures comprising soft magnetic core particles having improved electrical, magnetic and/or structural properties.

A further object of the technology proposed herein is to provide ferromagnetic powder compositions and mixtures comprising soft magnetic core particles providing an improved balance between two or more of electrical, magnetic, and structural properties.

A further object of the technology proposed herein is to provide a method of producing the powder compositions comprising soft magnetic core particles.

Yet a further object of the technology proposed herein is to provide a method of manufacturing an object from the ferromagnetic powder composition or mixture. Further objects of the technology proposed herein encompass an object manufactured from the ferromagnetic powder composition or mixture and an object comprising a compacted ferromagnetic powder composition or mixture.

### SUMMARY

At least one of the above-mentioned objects or at least one of the further objects which will become evident from the below description, are according to corresponding first and second aspects of the technology proposed herein achieved by a ferromagnetic powder composition comprising:
(i) soft magnetic iron-based core particles,
(ii) a first coating at least partially covering and being in direct contact with the surface of the core particles, the first coating comprising:
   a. a silicate of the general formula (K₂O)α(SiO₂)β, wherein α is moles of K₂O, β is moles of SiO₂, and the β/α molar ratio is in the interval from 0.5 to 4.1,
      i. wherein the silicate is present in an amount of 0.02 to 1.0 wt % calculated based on the total weight of the ferromagnetic powder composition,
   b. particles of a compound comprising bismuth and oxygen having a D₅₀ measured according to SS-ISO 13320-1 in the interval of 0.1 to 10 μm, and
   c. nanoparticles having a D₅₀ measured according to SS-ISO 13320-1 of 10-200 nm,
      and
      a method of producing a ferromagnetic powder composition comprising the steps of:
(i) providing soft magnetic iron-based core particles,
(ii) contacting the soft magnetic iron-based core particles with a first aqueous solution comprising:
   a. a silicate of the general formula (K₂O)α(SiO₂)β, wherein α is moles of K₂O, β is moles of SiO₂, and the β/α molar ratio is in the interval from 0.5 to 4.1,
      i. wherein the silicate is present in an amount of 0.02 to 1.0 wt % calculated based on the total weight of the ferromagnetic powder composition,
   b. particles of a compound comprising bismuth and oxygen having a D₅₀ measured according to SS-ISO 13320-1 in the interval of 0.1 to 10 μm, and
   c. nanoparticles having a D₅₀ measured according to SS-ISO 13320-1 of 10-200 nm.

At least one of the above-mentioned objects or at least one of the further objects which will become evident from the below description, are according to a third aspect of the technology proposed herein achieved by a method of manufacturing an object from the ferromagnetic powder composition or a ferromagnetic powder mixture, comprising the steps of:
(i) compacting the ferromagnetic powder composition or ferromagnetic powder mixture in a die at a compaction pressure in the range of 300-2000 MPa, preferably 400-1200 Mpa, to obtain a compacted part, and
(ii) heat treating the compacted part in a nonreducing atmosphere, preferably comprising 0-22 wt %, more preferably 0.5 to 2 wt % oxygen (O₂) at a temperature in the range 300-800° C., preferably 400-750° C., more preferably 600-700° C., to obtain the object.

At least one of the above-mentioned objects or at least one of the further objects which will become evident from the below description, are according to corresponding fourth and fifth aspects of the technology proposed herein achieved by an object obtained by the method according to the third aspect of the technology proposed herein and an object comprising a compacted ferromagnetic powder composition or compacted ferromagnetic powder mixture.

### BRIEF DESCRIPTION OF THE DRAWINGS

FIGS. 1A-1C show SEM and EDS mapping images of soft magnetic iron-based core particles coated with a silicate first coating.

FIGS. 2A-2C show SEM and EDS mapping images of soft magnetic iron-based core particles coated with a silicate first coating further comprising 20 mol % Y₂O₃ nanoparticles.

FIG. 3 shows a schematical cross-sectional illustration of a single particle of a ferromagnetic powder composition according to an embodiment of the first aspect of the technology proposed herein showing a soft magnetic iron-based core particle with a first coating comprising a silicate, nano particles and particles of a compound comprising bismuth and oxygen, as well as a second coating comprising at least one metal-organic compound.

### DETAILED DESCRIPTION

Corresponding first and second aspects of the technology proposed herein relates to a ferromagnetic powder composition comprising:
(i) soft magnetic iron-based core particles,
(ii) a first coating at least partially covering and being in direct contact with the surface of the core particles, the first coating comprising:
   a. a silicate of the general formula (K₂O)α(SiO₂)β, wherein α is moles of K₂O, β is moles of SiO₂, and the β/α molar ratio is in the interval from 0.5 to 4.1,
      i. wherein the silicate is present in an amount of 0.02 to 1.0 wt % calculated based on the total weight of the ferromagnetic powder composition,
   b. particles of a compound comprising bismuth and oxygen having a D₅₀ measured according to SS-ISO 13320-1 in the interval of 0.1 to 10 μm, and
   c. nanoparticles having a D₅₀ measured according to SS-ISO 13320-1 of 10-200 nm,
      and
      a method of producing a ferromagnetic powder composition comprising the steps of:
(i) providing soft magnetic iron-based core particles,
(ii) contacting the soft magnetic iron-based core particles with a first aqueous solution comprising:
   a. a silicate of the general formula (K₂O)α(SiO₂)β, wherein α is moles of K₂O, β is moles of SiO₂, and the β/α molar ratio is in the interval from 0.5 to 4.1,
      i. wherein the silicate is present in an amount of 0.02 to 1.0 wt % calculated based on the total weight of the ferromagnetic powder composition,
   b. particles of a compound comprising bismuth and oxygen having a D₅₀ measured according to SS-ISO 13320-1 in the interval of 0.1 to 10 μm, and
   c. nanoparticles having a D₅₀ measured according to SS-ISO 13320-1 of 10-200 nm.

Accordingly, the technology proposed herein is based on the realization by the present inventors that the magnetic and electrical properties of a ferromagnetic powder composition and parts made from the ferromagnetic powder composition can be improved by including nanoparticles in a first coating on the soft magnetic iron-based core particles. As observed from the examples and the figures, the inclusion of the nanoparticles in the first coating appears to lead to a more even distribution of the coating over the surface of the core particles. This improves the electrical insulation between the core particles, which leads to a higher resistivity of parts manufactured from the ferromagnetic powder composition. Additionally, the more distributed coating allows for more efficient compaction of the ferromagnetic powder composition, thus, maintaining or improving the density and magnetic properties of parts and objects manufactured from the ferromagnetic powder composition.

An additional advantage of the technology proposed herein is that the first coating can be applied in a single step using an aqueous solution of the silicate, the particles of a compound comprising bismuth and oxygen, and the nanoparticles.

In the ferromagnetic powder composition the silicate, the particles of a compound comprising bismuth and oxygen, and the nanoparticles, are all provided in the same first coating. In other words, the particles of a compound comprising bismuth and oxygen, and the nanoparticles, are dispersed in the silicate in the first coating, or have reacted such that the first coating is essentially a glass formed from the silicate and the particles of the compound comprising bismuth and oxygen, with the nanoparticles dispersed within. The particles of the compound comprising bismuth and oxygen and the nanoparticles may be substantially uniformly dispersed in the first coating.

The first coating of the ferromagnetic powder composition may be distinguished from a ferromagnetic powder composition with two separate coatings on a soft magnetic iron-based core particle. For example, the first coating may be distinguished from an oxide layer of nanoparticles and a glassy layer covering the oxide layer.

It has been surprisingly discovered that there is not a need to have a first oxide layer to create wetting conditions in order to anchor the glassy layer.

An advantage of the technology proposed herein is that the nanoparticles are provided in the same first coating as the silicate and the particles of a compound comprising bismuth and oxygen. As shown by Example 8, the nanoparticles provide a more even distribution in embodiments of the first coating. Moreover, the silicate is in a coating (the first coating) directly contacting the surface of the core particles, i.e., the silicate contacts the surface of the core particles. Embodiments of the ferromagnetic powder composition have a substantially unfirm distribution of the components of the first coating over the surface of the core particles, thereby improving electrical insulation and a more efficient compaction of ferromagnetic powder composition.

The ferromagnetic powder composition comprises a plurality of soft magnetic iron-based core particles.

The soft magnetic iron-based core particles comprise or consist of iron or an alloy of iron comprising at least 90% iron, preferably at least 99% iron, more preferably at least 99.5% iron. The alloy of iron may be alloyed iron Fe—Si having up to 7% by weight, preferably up to 3% by weight of silicon, alloyed iron selected from the groups Fe—Al, Fe—Si—Al, Fe—Ni, Fe—Co, Fe—Ni—Co, or combinations or mixtures of such alloys. The soft magnetic iron-based core particles may comprise mixtures of particles such as mixtures of iron particles and iron alloy particles or a mixture of particles made from two or more iron alloys. Preferably the soft magnetic iron-based core particles are made of essentially pure iron, i.e. iron with inevitable impurities. Preferably at least 80 wt %, more preferably at least 90 wt %, of all of the core particles have a diameter is in the range 20-1000 μm, measured according to ISO 4497.

Within this range, more specific ranges may be more suitable depending on the intended use of the part, component or object that is to be produced from the ferromagnetic powder composition. Thus, for high frequency applications, such as sensors, inductors, and converters, preferably at least 80 wt %, more preferably at least 90 wt % such as at least 99 wt %, based on the total weight of the core particles, of the core particles are in the range 20-75 μm (200 mesh corresponding to a D₅₀ of approximately 45 μm), as measured according to ISO 4497. For low to medium frequency applications, such as electric motors, generators, and converters, preferably at least 80 wt %, more preferably at least 90 wt % such as at least 99 wt %, based on the total weight of the core particles, of the core particles are in the range 45-150 μm (100 mesh corresponding to a D₅₀ of approximately 95-100 μm), as measured according to ISO 4497. For low frequency applications, such as electric motors, preferably at least 80 wt %, more preferably at least 90 wt % such as at least 99 wt %, based on the total weight of the core particles, of the core particles are in the range 75-380 μm (40 mesh corresponding to a D₅₀ of approximately 180-210 μm), as measured according to ISO 4497.

The soft magnetic iron-based core particles may be spherical or irregular shaped, irregular shaped particles being preferred. The AD (apparent density) may be between 2.8 and 4.0 g/cm³, preferably between 3.1 and 3.7 g/cm³.

The soft magnetic iron-based core particles may be water atomized, gas atomized or a sponge iron powder.

The first coating is at least partially covering and is in direct contact with surface of the core particles. Preferably the first coating covers all of the surface of at least 50 wt %, such as at least 75 wt % of the core particles in the ferromagnetic powder composition. More preferably, the first coating covers all of the surface of at least 90 wt %, such as at least 95 wt % of the core particles in the ferromagnetic powder composition.

Partially covering means that the first coating may cover at least 50% of the surface area of at least 50 wt %, such as at least 75 wt %, such as at least 90 wt % of the core particles. Typically, the first coating has an average thickness in the range of 20-100 nm. The coating thickness may be estimated from the permeability where a maximum relative magnetic permeability of about 3000 correspond to zero thickness and a maximum relative magnetic permeability of about 700 corresponds to a thickness of about 20 nm for 40 mesh core particles.

The silicate of the general formula (K₂O)α(SiO2)β is a potassium silicate or alternatively named K-silicate, K-waterglass, potassium waterglass or simply herein silicate.

The β/α molar ratio (i.e. the molar ratio of SiO₂ to K₂O) is in the interval from 0.5 to 4.1. Preferably, the molar ratio β/α is in the interval of 2.00 to 3.75. More preferably the molar ratio β/α is in the interval of 2.5 to 3.5.

The silicate is present in the amount 0.02 to 1.0 wt %, more preferably 0.05-0.5 wt % calculated based on the total weight of the ferromagnetic powder composition. Preferably, the silicate is present in the amount 0.05-0.2 wt % calculated based on the total weight of the ferromagnetic powder composition when at least 80 wt %, based on the total weight of the core particles, of the core particles are 75 μm or more, and 0.1-0.5 wt % calculated based on the total weight of the ferromagnetic powder composition when at least 80 wt %, based on the total weight of the core particles, of the core particles are below 75 μm. The first coating may be applied as shown using an aqueous solution and it has been found that when soft magnetic iron-based core particles are contacted with such a solution substantially all of the silicate and other components, e.g. nanoparticles and particles of a compound comprising bismuth and oxygen, end up in the first coating. Accordingly, contents and ratios between components in the aqueous solution and the soft magnetic iron-based core particles carry over to the contents and ratios between components in the first coating and the soft magnetic iron-based core particles.

The particles of a compound comprising bismuth and oxygen preferably comprise oxides and hydroxides of bismuth. Preferably the D₅₀ measured according to SS-ISO 13320-1 is in the interval of 0.5 to 2 μm.

The contacting of the soft magnetic iron-based core particles with the first aqueous solution may be performed by mixing, e.g., in a mixer. The result of contacting the soft magnetic iron-based core particles with the first aqueous solution is that the first coating is formed on the magnetic iron-based core particles so as to at least partially cover the magnetic iron-based core particles. In other words, the method according to the second aspect of the technology proposed herein produces soft magnetic iron-based core particles coated with the first coating, i.e., the ferromagnetic powder composition according to the first aspect of the technology proposed herein. The soft magnetic iron-based core particles coated with the first coating and optionally also coated with the second coating as described below may alternatively be referred to as coated core particles or coated soft magnetic iron-based core particles.

The D₅₀ measured according to SS-ISO 13320-1 is defined in SS-ISO 13320-1 as the median particle diameter used on a volumetric basis, i.e., 50% by volume of the particles is smaller than this diameter and 50% is larger.

The D₅₀ measured according to SS-ISO 13320-1 can be determined using e.g., a Mastersizer 3000 from Malvern instruments.

An alternative parameter for determining the size of the nanoparticles is the specific surface area (SSA) [m²/g], i.e., the surface area of the particles per g of particles.

Accordingly, a D₅₀ measured according to SS-ISO 13320-1 of 10-200 nm may be equivalently replaced by a specific surface area (SSA) in the range of 6-120 m²/g.

The SSA for the nanoparticles is preferably determined using the BET-method, which is a method for determination of the specific surface area of solids by gas adsorption.

More preferably, the SSA for the nanoparticles is preferably determined according to ISO 9277:2010, or preferably ISO 9277:2022.

Accordingly, a D₅₀ measured according to SS-ISO 13320-1 of 10-200 nm may be equivalently replaced by a specific surface area (SSA) of 6-120 m²/g as determined according to ISO 9277:2010 or preferably ISO 9277:2022.

Preferably, the specific surface area (SSA) of the nanoparticles is 10-50, more preferably 10-30, such as 15-25, preferably 15-20, most preferably 18, m²/g. As above, these ranges are preferably determined according to ISO 9277:2010 or preferably ISO 9277:2022.

The specific surface area may be measured using a Micromeritics TriStar 3000 gas adsorption instrument which calculates the BET surface area.

For comparison, an average diameter for the nanoparticles may be calculated from the specific surface area if the particles are assumed to be spherical. The equation for calculating the average particle diameter in nanometres is 6000/(BET surface area in m²/g)×(density in g/cm³). For Y₂O₃ (density 5.01 g/cm³), the specific surface areas of 120, 6, 50, 10, and 18 m²/g respectively yield the average diameters of 10, 200, 24, 120, and 67 nm respectively.

The nanoparticles are preferably selected from the group consisting of Y₂O₃ nanoparticles, ZrO₂ nanoparticles, ZnO nanoparticles, MgOH₂ nanoparticles, MgO nanoparticles, CaCO₃ nanoparticles, Al₂O₃ nanoparticles, SiO₂ nanoparticles, and TiO₂ nanoparticles, and the nanoparticles preferably comprise or consist of Y₂O₃ nanoparticles.

As seen in example 3a, numerous different nanoparticles are effective in obtaining improved magnetic and electric properties for objects manufactured from the ferromagnetic powder composition. Further, Example 3a shows that Y₂O₃ nanoparticles, also known as yttria nanoparticles and Yttrium oxide nanoparticles, provides the currently considered best magnetic and electric properties. The nanoparticles may comprise a mixture of nanoparticles, such as a mixture of two or more of the listed nanoparticles. Presently, preferred is however that only one type of nanoparticles, e.g., preferably Y₂O₃ nanoparticles, is present in the first coating.

The content of nanoparticles in the first coating is preferably 1-30 mol %, preferably 1-20 mol % based on the molar content of K (potassium) in the first coating. As seen in example 1a and 3a, these general molar contents of nanoparticles provide good results. Further, for reference, 20 mol % Y₂O₃ particles when included in a first coating comprising 0.1 wt % potassium silicate with a β/α ratio of 3.4 on 5 kg of soft magnetic iron-based core particles corresponds to 0.94 g Y₂O₃ particles, i.e. 0.0188 wt % based on the weight of the ferromagnetic powder composition.

Preferably the nanoparticles have a D₅₀ measured according to SS-ISO 13320-1 of 1-100 nm or 50-200 nm, preferably 1-50 nm, more preferably 5-50 nm, such as 30-50 nm or such as 5-20 nm such as 10 nm.

More preferably, the nanoparticles have a D₅₀ measured according to SS-ISO 13320-1 of 10-100 nm. Most preferably the nanoparticles have a D₅₀ measured according to SS-ISO 13320-1 of 20-100 nm.

The former interval corresponds to a SSA of 12-120 m²/g, whereas the latter interval corresponds to a SSA of 12-60 m²/g.

The D₅₀ measured according to SS-ISO 13320-1 is preferably between 10 and 100 nm, where 90 wt % of the particles shall have maximum diameters between 1 and 500 nm.

Alternatively, the nanoparticles have a diameter of 1-100 nm or 50-200 nm, preferably 1-50 nm, more preferably 5-50 nm, such as 30-50 nm or such as 5-20 nm such as 10 nm. In the examples the nanoparticles generally have a D₅₀ of 10 nm, and this size of nanoparticles has been shown to provide the best results.

When performing the method according to the second aspect of the technology proposed herein, it may occur that the nanoparticles as provided or obtained are agglomerated into agglomerates having a diameter above 200 nm and/or such that the agglomerated nanoparticles have a D₅₀ above 200 nm. These agglomerates should preferably be fully or partially disintegrated so as to obtain, or increase the content of, nanoparticles having the desired D₅₀ or diameter of 1-200 nm or smaller as preferred above because well distributed nanoparticles within the first coating is preferred. Where the nanoparticles used in the method comprises significant amounts of agglomerates, and when no further disintegration is performed on the nanoparticles, then the mol % of nanoparticles in the first coating may preferably be increased compared to when nanoparticles comprising no or only a minor amount of agglomerates and having a lower D₅₀ or diameter are used.

The disintegration preferably takes place before or during the preparation of the first aqueous solution, or during the contacting of the soft magnetic iron-based core particles with the first aqueous solution. As an example, sonication may be used for disintegration.

Preferably, the first coating comprises:
10-25 mol %, more preferably 15-22 mol % such as 20 mol % Y₂O₃ nanoparticles based on the content of K in the first coating, or
1-20 mol %, preferably 1-15 mol %, more preferably 1-10 mol % such as 5 mol % ZrO₂ nanoparticles based on the content of K in the first coating, or
1-20 mol %, preferably 5-20 mol %, more preferably 10-20 mol % MgOH₂ nanoparticles based on the content of K in the first coating, or
1-20 mol %, preferably 5-20 mol %, more preferably 10-20 mol % CaCO₃ nanoparticles based on the content of K in the first coating, or
1-20 mol %, preferably 5-20 mol %, more preferably 10-20 mol % ZnO nanoparticles based on the content of K in the first coating, or
1-30 mol %, preferably 10-30 mol %, more preferably 15-25 mol % such as 20 mol % MgO nanoparticles based on the content of K in the first coating, or
1-30 mol %, preferably 10-30 mol %, more preferably 15-25 mol % such as 20 mol % TiO₂ nanoparticles based on the content of K in the first coating, or
1-20 mol %, preferably 5-15 mol %, more preferably 10 mol % Al₂O₃ nanoparticles based on the content of K in the first coating, or
1-20 mol %, preferably 1-10 mol %, more preferably 5 mol % ZnO nanoparticles based on the content of K in the first coating.

Examples 1a and 3a show that these contents of the various nanoparticles give good results. As above, different nanoparticles according to these ranges may be combined in the first coating.

Preferably the content of the particles of the compound comprising bismuth and oxygen in the first coating is 0.025-0.3 wt %, preferably 0.05-0.25 wt %, more preferably 0.07-0.22 wt %, such as 0.08-0.22 wt %, such as 0.08-0.11 wt %, calculated based on the total weight of the ferromagnetic powder composition.

Example 3a shows that these ranges of content of the particles of the compound comprising bismuth and oxygen give good results.

The content of 0.08-0.11 wt % is currently the best range for soft magnetic iron-based core particles sized as 100 mesh.

When the soft magnetic iron-based core particles are larger, e.g., of 40 mesh size, the content of the particles of the compound comprising bismuth is preferably at least 0.05 wt %, such as 0.05-0.10 wt %.

When the soft magnetic iron-based core particles are smaller, e.g., of 200 mesh size, the content of the particles of the compound comprising bismuth is preferably at least 0.15 wt %, such as 0.15-0.30 wt %.

The compound comprising bismuth and oxygen may be selected from the group consisting of bismuth(III) oxide (Bi₂O₃) and bismuth(III) hydroxide (Bi(OH)₃), wherein the compound comprising bismuth and oxygen preferably is Bi(OH)₃. As shown in Example 1a and 1b, and Example 2, the presence of Bi₂O₃ or Bi(OH)₃ particles increase resistivity. Further, as shown in Example 1b, the resistivity is increased more for Bi(OH)₃ particles than for Bi₂O₃ particles. It is disclosed herein the ferromagnetic powder composition as described above wherein the first coating is applied by contacting the soft magnetic iron-based core particles with a first aqueous solution comprising:
a silicate of the general formula (K2O)α(SiO2)β, wherein α is moles of K2O, β is moles of SiO2, and the β/α molar ratio is in the interval from 0.5 to 4.1,
wherein the silicate is present in an amount of 0.02 to 1.0 wt % calculated based on the total weight of the ferromagnetic powder composition,
particles of a compound comprising bismuth and oxygen having a D50 measured according to SS-ISO 13320-1 in the interval of 0.1 to 10 μm, and
nanoparticles having a D50 measured according to SS-ISO 13320-1 of 10-200 nm.

The ferromagnetic powder composition preferably further comprises:
(iii) a second coating at least partially covering the surface of the core particles and/or the first coating, the second coating comprising:
   a. at least one metal-organic compound having the general formula:

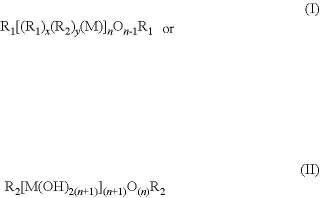

wherein M is selected from the group consisting of Si, Ti, Al, and Zr; O is oxygen; R₁ is a hydrolysable group; R₂ is an organic moiety and wherein at least one R₂ contains at least one amino group; wherein n is the number of repeating units being an integer between 1 and 20; wherein x is 0 or 1; and wherein y is 1 or 2, and x+y is 2,
wherein the content of the at least one metal-organic compound is 0.05 to 0.40 wt %, preferably 0.1 to 0.30 wt %, based on the total weight of the ferromagnetic powder composition.

The second coating further improves the electrical, structural, and magnetic properties of components or parts manufactured from the ferromagnetic powder composition.

R₁ may be an alkoxy-group having less than 4, preferably less than 3 carbon atoms. R₂ is an organic moiety, which means that the R₂-group contains an organic part or portion. R₂ preferably includes 1-6, more preferably 1-3, carbon atoms. R₂ may further include one or more hetero atoms selected from the group consisting of N, O, S and P. The R₂ group may be linear, branched, cyclic, or aromatic. R₂ may include one or more of the following functional groups: amine, diamine, amide, imide, epoxy, hydroxyl, ethylene oxide, ureido, urethane, isocyanato, acrylate, glyceryl acrylate, benzyl-amino, vinyl-benzyl-amino. The R₂ group may alter between any of the mentioned functional R₂-groups and a hydrophobic alkyl group with repeatable units.

When n=1 the metal-organic compound is a monomer (formula I) or a dimer (Formula II). If the metal-organic compound is a monomer it may be selected from the group of trialkoxy and dialkoxy silanes, titanates, aluminates, or zirconates. The monomer of the metal-organic compound may thus be selected from 3-aminopropyl-trimethoxysilane, 3-aminopropyl-triethoxysilane, 3-aminopropyl-methyl-diethoxysilane, N-aminoethyl-3-aminopropyl/ethyl/methyl-alkoxy-silane such as N-aminoethyl-3-aminopropyl-trimethoxysilane and N-aminoethyl-3-aminopropyl-methyl-dimethoxysilane, 1,7-bis(triethoxysilyl)-4-azaheptan, triamino-functional propyl-trimethoxysilane, 3-ureidopropyl-triethoxysilane, 3-isocyanatopropyl-triethoxysilane, tris(3-trimethoxysilylpropyl)-isocyanurate, O-(propargyloxy)-N-(triethoxysilylpropyl)-urethane, 1-aminomethyl-triethoxysilane, 1-aminoethyl-methyl-dimethoxysilane, or mixtures thereof. When n=2-20 the metal-organic compound is an oligomer. An oligomer of the metal-organic compound may be selected from alkoxy-terminated alkyl-alkoxy-oligomers of silanes, titanates, aluminates, or zirconates. The oligomer of the metal-organic compound may thus be selected from methoxy, ethoxy or acetoxy-terminated amino-silsesquioxanes, amino-siloxanes, oligomeric 3-aminopropyl-methoxy-silane, 3-aminopropyl/propyl-alkoxy-silanes, N-aminoethyl-3-aminopropyl-alkoxy-silanes, or N-aminoethyl-3-aminopropyl/methyl-alkoxy-silanes or mixtures thereof.

Examples of suitable metal-organic compounds in particular include Dynasylan® 1146 and Dynasylan® SIVO 203 from Evonik Industries AG.

Water-borne amino- or multifunctional silane systems are also comprised by the metal-organic compound, such as the corresponding Dynasylan® HYDROSIL products supplied by Evonik industries AG. In these products the hydrolysable alkoxy-groups have almost fully been replaced with hydroxyl groups, i.e., as per Formula (II), while the functionality is similar, e.g., hydrophobic alkyl-groups in combination with amino- or diamino-alkyl-groups. Examples include the HYDROSIL 2627, 2776, and 1151 silane systems. Examples of such compounds can be 1,3-Bis(3-aminopropyl)disiloxane-1,1,3,3-tetrol or (3-aminopropyl)({[(propyl)dihydroxysilyl]oxy})silanediol.

Example 5 shows that a wide variety of metal organic compounds in the second coating can be used successfully in the ferromagnetic powder composition.

Preferably, the at least one metal-organic compound has the general formula (I). Alternatively, the at least one metal-organic compound has the general formula (II).

The ferromagnetic powder composition preferably further comprises a lubricant, preferably a particulate lubricant.

Including a lubricant in the ferromagnetic powder composition improves compaction and leads to an increased density and strength of an object manufactured from the ferromagnetic powder composition. The lubricant may be selected from the group consisting of primary and secondary fatty acid amides, trans-amides (bisamides) or fatty acid amides or alcohols. The lubricating moiety of the lubricant may be a saturated or unsaturated chain containing between 12-22 carbon atoms. The lubricant may preferably be selected from stearamide, erucamide, stearylerucamide, erucyl-stearamide, behenyl alcohol, erucyl alcohol, ethylene-bisstearmide (i.e., EBS or amide wax). Preferably the lubricant is an amide wax. Preferably is also a mixture of stearamide or behenyl alcohol and an amide wax. One example is 0.1 wt % stearamide combined with 0.3 wt % amide wax.

The lubricant may be present in an amount of 0.05-0.80 wt %, preferably 0.20-0.40 wt % of the ferromagnetic powder composition. Example 6 shows that a number of different lubricants are useable.

The ferromagnetic powder composition according to the first aspect of the technology proposed herein is preferably used in a ferromagnetic powder mixture.

The ferromagnetic powder mixture may comprise:
the ferromagnetic powder composition according to the first aspect of the technology proposed herein, and
a further ferromagnetic powder composition,

wherein the further ferromagnetic powder composition comprises soft magnetic iron-based core particles that are different from the soft magnetic iron-based core particles of the ferromagnetic powder composition, and

wherein preferably the soft magnetic iron-based core particles of the further ferromagnetic powder composition comprise or consist of an iron alloy having a higher electrical resistivity than the soft magnetic iron-based core particles of ferromagnetic powder composition.

This is advantageous in that it allows the magnetic and electrical properties of components or parts manufactured from the ferromagnetic powder composition to be further adjusted. If, as preferred, the soft magnetic iron-based core particles of the further ferromagnetic powder composition comprise or consist of an iron alloy having a higher electrical resistivity than the soft magnetic iron-based core particles of ferromagnetic powder composition, then the ferromagnetic powder mixture will have a lower core loss at higher frequencies. Further, as surprisingly shown in Example 7a, the ferromagnetic powder mixture also had more than acceptable mechanical strength (TRS) at the tested wt % (30 wt %) of added further ferromagnetic powder composition. This allows increasing the content of the further ferromagnetic powder composition with its iron-alloy based core particles beyond 30 wt %, and thus provides for manufacturing useable components, due to acceptable mechanical strength, with even lower total core loss at higher frequencies.

The soft magnetic iron-based core particles of the further ferromagnetic powder composition preferably comprise or consist of an iron alloy selected from the group consisting of FeSl, FeAl, FeSiAl, FeNi, FeCo, and FeNiCo, or combinations or mixtures of such alloys. Especially preferred are FeSl (typically 3-6.8 wt % Si) and FeSiAl (also known as Sendust; typically 9 wt % Si and 6 wt % Al).

The content of the further ferromagnetic powder composition may be up to 60 wt % such as 30-60 wt %, but is typically from 10-50 wt %, such as from 20-40 wt %, such as 20-30 wt %, based on the weight of the ferromagnetic powder mixture with the ferromagnetic powder composition according to the first aspect of the technology proposed herein making up the remainder.

In the powder mixture the soft magnetic iron-based core particles of the ferromagnetic powder composition preferably comprises or consists of essentially pure iron, i.e., iron with inevitable impurities.

Preferably the further ferromagnetic powder composition further comprises a coating or surface treatment on the soft magnetic iron-based core particles therein. The coating or surface treatment preferably comprises the first, and optionally also the second, coating as described above. Typically, however, when comprising an iron alloy, the soft magnetic iron-based core particles of the further ferromagnetic powder composition may be coated or treated with a less insulating coating or treatment, such as by being treated with phosphoric acid, e.g. in acetone, due to the higher resistivity of the iron alloy compared to essentially pure iron and due to such a coating being capable of withstanding heat treatment at higher temperatures such as 700° C.

The soft magnetic iron-based core particles of the further ferromagnetic powder composition preferably have the same particle sizes as the soft magnetic iron-based core particles of the ferromagnetic powder composition according to the first aspect of the technology proposed herein as described further above.

The method according to the second aspect of the technology proposed herein may further comprise one or more of the steps of:
(iii) drying the coated soft magnetic iron-based core particles, and/or
(iv) contacting the coated soft magnetic iron-based core particles with at least one metal-organic compound as described above, and/or
(v) mixing the coated soft magnetic iron-based core particles with a lubricant as described above.

Step (iii) is preferably performed after step (ii). Step (iii) may be performed by heating the soft magnetic iron-based core particles while stirring.

Step (iv) is preferably performed after step (ii) or (iii), and before step (v).

Step (v) is preferably performed after step (iii) and step (iv).

The third aspect of the technology proposed herein relates to a method of manufacturing an object from the ferromagnetic powder composition or the ferromagnetic powder mixture, comprising the steps of:
(i) compacting the ferromagnetic powder composition or the ferromagnetic powder mixture in a die at a compaction pressure in the range of 300-2000 MPa, preferably 400-1200 MPa, to obtain a compacted part, and
(ii) heat treating the compacted part in a nonreducing atmosphere, preferably comprising 0-22 wt %, more preferably 0.5 to 2 wt % 02 at a temperature in the range 300-800° C., preferably 400-750° C., more preferably 600-700° C., to obtain the object.

The compaction may be cold die compaction, warm die compaction, or high-velocity compaction, preferably a controlled die temperature compaction (50-120° C.) with an unheated powder is used. During the compaction, the coated soft magnetic iron-based core particles are pressed together and deformed so as to adhere to each other and form the compacted part. During the heat treatment the particles of the compound comprising bismuth and oxygen together with the nanoparticles and the silicate in the first coating and the amino and/or alkyl groups of the metal-organic compound of the second coating form an evenly distributed bismuth-silicate glass on the surface of the soft magnetic iron-based core particles which provides the desired electrical resistivity between the individual particles of the compacted and heat treated ferromagnetic powder composition in the finished object. Additionally, the heat treatment decreases the stress formed during the compaction.

The heat treatment process may be in vacuum, non-reducing, inert or in weakly oxidizing atmospheres, e.g. 0.01 to 3 wt % oxygen in nitrogen. In one embodiment, an essentially pure nitrogen atmosphere is used as a non-reducing atmosphere. In one embodiment with addition of 0-22 wt % oxygen, preferably 0.5-2 wt % oxygen. Optionally, the heat treatment is performed in an inert atmosphere and thereafter exposed quickly in an oxidizing atmosphere, such as 0.5-22 wt % oxygen/nitrogen mixtures or in steam/nitrogen mixtures, to build a superficial crust of higher strength and/or corrosion resistance. The temperature may in one embodiment be up to 800° C.

Corresponding fourth and fifth aspects of the technology proposed herein relate to an object obtained by the method according to the third aspect of the technology proposed herein and an object comprising a compacted ferromagnetic powder composition or compacted ferromagnetic powder mixture.

The object may alternatively be referred to as a part or a component and may be selected from the group consisting of a soft magnetic component of a sensor, inductor, converter, transformer, electric motor, and a generator.

### EXAMPLES

In the following examples various ferromagnetic powder compositions comprising soft magnetic iron-based core particles according to the first aspect of the technology proposed herein were produced by coating the soft magnetic iron-based core particles with various first and second coatings as per various embodiments of the method according to the second aspect of the technology proposed herein. The ferromagnetic powder compositions were then used to produce test parts or test objects which were compacted and heat treated according to various embodiments of the method according to the third aspect of the technology proposed herein. The finished test parts were finally investigated for relevant properties such as resistivity Res and permeability μ-max.

More specifically, the test parts used in the examples were produced in the following steps:
Step 1: Soft magnetic iron-based core particles were mixed (10 min) with an aqueous solution of a silicate of the general formula (K₂O)α(SiO2)β (potassium silicate, Sibelco Nordic AB, β/α molar ratio of 3.37, solids content 14 wt %) at a concentration (based on dry matter content) of 0.1 wt % to form the first coating on the core particles. The aqueous solution further contained one or more additional compounds or additives of interest as specified for each sample. After the initial mixing, the core particles where dried while being stirred at 60° C. for 1 h, followed by further drying without stirring at 120° C.
Step 2: The mixture from step 1 was mixed with a silane (oligomeric diaminofunctional silane Dynasylan® 1146 from Evonik Industries AG, 1.5 g in 1 g H₂O unless otherwise specified) for 5 min so as to form the second coating, and the resulting mixture was dried at 50° C. for 2 h to produce a finished ferromagnetic powder composition comprising coated soft magnetic iron-based core particles.
Step 3. A lubricant (0.4 wt % amide wax unless otherwise specified) was added to the ferromagnetic powder composition in order to facilitate producing the test part, and the ferromagnetic powder composition was then shaped and compacted (800 MPa with a die temperature of 100° C.) into test parts which were heat treated to release stress from the compaction to form the finished test parts.

The soft magnetic iron-based core particles were a water atomized annealed iron powder having dimensions according to 100 mesh and an apparent density of 3.32 g/cm³ unless otherwise stated.

The heat treatment was performed in three stages in a pre-heated furnace. The three stages comprised a delubrication stage at about 300-400° C. during which the compacted part was heated up towards the curing stage, a curing stage at about 350-450° C. (first time and temperature given for each sample) in which the coating was cured so as to cause the formation of an electrically insulating bismuth-silicate glass from the first and second coating, and a relaxation stage at 600-700° C. (second time and temperature given for each sample) in which the stress from the compaction was released. The oxygen partial pressure during the heat treatment was 15000 ppm (1.5 wt % oxygen in nitrogen) unless otherwise specified.

The finished test parts (OD55/ID45/H5 mm magnetic square toroids) were subjected to test to determine inter alia:
Electrical resistivity (Res)—how the material resists electric current [μΩm]. Measured using 4-point probe method with 20 mm distance between measuring points.
Coercivity*(H_{c}) at 10 kA/m [A/m]*For the measurement of magnetic properties, the square toroids were wound with 100 drive and 100 sense turns of resin coated copper wire (diameter 0.63 mm) and measured using a Brockhaus MPG 200D. References: IEC 60404-4 (DC measurements) and IEC 60404-6 (AC-measurements).
Maximal permeability*(μ-max)—the maximum value of the ratio between the magnetization that a material obtains in response to an applied magnetic field [unitless].
Square toroid density (d)—density of the square toroid test part [g/cm³].
Magnetic flux density*—induction obtained for a given applied magnetic field [T].
B4*—magnetic flux density at 4 kA/m [T],
B10*—Magnetic flux density at 10 kA/m [T]
Total core loss*(at 1T/1 kHz)—total core loss for a test part obtained for a given induction and frequency [W/kg].
TRS—Transverse rupture strength according to SS-EN ISO 3325:2000, on bars with dimensions of 30×12×6 mm [MPa].
AD—Apparent density according to ISO standard 3923-1:2018 measured as the ratio between the dry mass and apparent volume of the powder sample [g/cm³].
FLOW—Hall flow according to SS-EN ISO 4490:2018 [seconds].
GS—Green strength, measured as TRS but on test parts prior to heat treatment [MPa].

### Example 1a: Yttria (Y₂O₃) Nanoparticles in the First Coating Improves Resistivity R and Permeability μ-Max for a Given Coercivity Hc(10 kA/m in a Heat Treated Formed Component

Example 1a tested the effects of including Y₂O₃ nanoparticles (nominally 10 nm) at 10, 20 and 30 mol % respectively (based on the molar weight of K) and Bismuth oxide (Bi₂O₃) at a concentration of 0.1 wt % in the aqueous solution of the silicate in step 1 when producing the coated soft magnetic iron-based core particles in step 2. The test resulted in four different test parts made according to step 3 which were tested for determining their properties relative to the reference 1 and reference 2 as listed in table 1a below.

Reference 2 was included to provide further reference data for the nanoparticle samples. Reference 2 was produced using an alternative process using phosphoric acid. Specifically, in the alternative process step 1 was divided into substeps 1a-1c, wherein:
substep 1a consisted of mixing soft magnetic iron-based core particles with an aqueous solution of a silicate of the general formula (K₂O)α(SiO2)β and drying the mixture to obtain dried particles,
substep b consisted of treating the dried particles with diluted phosphoric acid (25-75 g/l water), and
substep c consisted of mixing the particles with Bismuth oxide (Bi₂O₃).

TABLE 1a

| | | | | | Total |
|---|---|---|---|---|---|
| | | | | | Core |
| Sample | Constitution and conditions | Res | Hc | μ-max | loss |
| Ref 1 | reference 1 (0.1 wt % Bi₂O₃), no Y₂O₃ nanoparticles | | | | |
| | 450/650 °C (30/30 min) | 1435 | 135.0 | 456 | 81.2 |
| Ref 2 | reference 2 (0.1 wt % Bi₂O₃ + Phosphoric acid) | | | | |
| | 450/650 °C (30/30 min) @ | 8970 | 142.5 | 535 | 79.7 |
| | 15000 ppm | | | | |
| | 450/670 °C (30/30 min) @ | 1053 | 135.2 | 570 | 78.2 |
| | 15000 ppm | | | | |
| 1-1 | 10 mol % Y₂O₃ + 0.1 wt % Bi₂O₃ | | | | |
| | 450/650 °C (30/30 min) | 657 | 131.3 | 665 | 78.2 |
| | 450/670 °C (30/30 min) | 56 | 133.5 | 646 | 95.4 |
| 1-2 | 20 mol % Y₂O₃ + 0.1 wt % Bi₂O₃ | | | | |
| | 450/650 °C (30/30 min) | 3368 | 134.8 | 599 | 77.6 |
| | 450/670 °C (30/30 min) | 244 | 135.0 | 620 | 80.8 |
| 1-3 | 30 mol % Y₂O₃ + 0.1 wt % Bi₂O₃ | | | | |
| | 450/650 °C (30/30 min) | 294 | 131.0 | 606 | 79.6 |
| | 450/670 °C (30/30 min) | 278 | 136.0 | 605 | 81.3 |
| 1-4 | 20 mol % Y₂O₃ + 0.11 wt % Bi(OH)₃ | | | | |
| | 450/650 °C (30/30 min) @ | 6877 | 138.2 | 536 | 78.7 |
| | 15000 rpm | | | | |
| | 450/670 °C (30/30 min) @ | 4660 | 132.3 | 556 | 77.4 |
| | 15000 rpm | | | | |

As seen from the results, the inclusion of 20 MOI % Y₂O₃ nanoparticles (sample 1-2) provided a resistivity of 3368 μΩm and a coercivity of 134.8 A/m at a heat treatment of 450/650° C. In comparison, the reference 1 sample provided a significantly lower resistivity of 1435 μΩm. Sample 1-2 also provided higher μ-max and lower total core loss. Thus, sample 1-2 provided overall better properties than the reference 1 sample for forming soft magnetic components or parts.

Further, it can be seen that the reference 2 sample, in order to reach a similarly low coercivity of 135.2 as that of reference sample 1 and sample 1-2, had to be heat treated at the higher temperatures 450/670°. This, however, resulted in an even lower resistivity of 1053 μΩm.

Table 1a further shows that the inclusion 20 MOI % Y₂O₃ nanoparticles (sample 1-2) provides overall better properties than 10 mol % (sample 1-1) and 30 mol % (sample 1-3), which samples have lower resistivity. Sample 1-1 at a heat treatment of 450/650° C., however, provides a moderate resistivity with among the lowest coercivity and the highest permeability.

Additionally, table 1a also shows that bismuth hydroxide (Bi(OH)₃ significantly increases resistivity (sample 4) compared to bismuth oxide (Bi₂O₃) (sample 1-2) at both heat treatments, however, with slightly lower permeability. Without wishing to be bound by theory, this is believed to depend on the hydroxide being less prone to be reduced by the carbon in the metal-organic compound second layer.

From Example 1a it may thus be concluded that the amount of Y₂O₃ nanoparticles in the first coating may suitably be between 10 and 30 mol %, preferably 15-25 mol %, more preferably 18-22 mol % such as 20 mol %, based on the amount of K in the silicate. It may further be concluded that the inclusion of Y₂O₃ nanoparticles provided better properties than treatment of the core particles using phosphoric acid as per the alternative process. It may further be concluded that the first coating may comprise bismuth oxide (Bi₂O₃) or bismuth hydroxide (Bi(OH)₃), preferably bismuth hydroxide (Bi(OH)₃).

Unless otherwise specified in the below further examples, bismuth hydroxide (Bi(OH)₃), at a concentration of 0.08 wt % were used. Further, unless otherwise specified, the nanoparticles were Y₂O₃ nanoparticles with a nominal D₅₀ diameter of 10 nm and the content of nanoparticles were 20 mol % based on the amount of K in the silicate first coating.

### Example 1b: Further Experiment Using 20 Mol % Y₂O₃ Nano Particles—Effects of Silicate Concentration and Silane Concentration

Further experiments were made using the same conditions as in Example 1a but with different contents of the first and second coatings, i.e. different silicate and silane concentrations (at a heat treatment of 450/650° C. (30/30 min)). Experiment parameters and results are presented in table 1b below:

TABLE 1b

| | Constitution | | | | | | | | | Total |
|---|---|---|---|---|---|---|---|---|---|---|
| | and | | | | | | | μ- | | core |
| Sample | conditions | GS | TRS | d | Res | B4 | B10 | max | Hc | loss |
| 1-5 | 0.10 wt % | 9.1 | 57.7 | 7.46 | 9072 | 1.3 | 1.57 | 477 | 138.2 | 79.9 |
| | Bi₂O₃ | | | | | | | | | |
| 1-6 | 0.08 wt % | 9.6 | 56.2 | 7.46 | 13253 | 1.3 | 1.57 | 475 | 138.9 | 79.4 |
| | Bi(OH)₃ | | | | | | | | | |
| 1-7 | As sample | 9.9 | 52.0 | 7.47 | 4301 | 1.32 | 1.59 | 513 | 141.3 | 80.1 |
| | 1-6 but 0.5 × | | | | | | | | | |
| | second | | | | | | | | | |
| | coating | | | | | | | | | |
| | (metal- | | | | | | | | | |
| | organic | | | | | | | | | |
| | compound) | | | | | | | | | |
| 1-8 | As sample | 9.0 | 62.3 | 7.49 | 239 | 1.39 | 1.62 | 675 | 135.4 | 81.5 |
| | 1-6 but 0.5 × | | | | | | | | | |
| | first coating | | | | | | | | | |
| | (silicate + | | | | | | | | | |
| | Bi(OH)₃ + | | | | | | | | | |
| | Y₂O₃) | | | | | | | | | |
| 1-9 | As sample | 9.5 | 66.9 | 7.48 | 109 | 1.4 | 1.62 | 708 | 135.6 | 87.9 |
| | 1-7 and | | | | | | | | | |
| | sample 1-8 | | | | | | | | | |

As seen from the table, bismuth hydroxide (Bi(OH)₃) significantly increases resistivity (sample 1-6) compared to Bismuth oxide (Bi₂O₃) (sample 1-5). Halving the silane content in the second coating still produces acceptable resistivity (sample 1-7). Halving the addition of the first coating (silicate, Bi(OH)₃, and Y₂O₃) produces low resistivity (sample 1-8, sample 1-9).

From example 1b, it may be concluded that the silane content in the second coating may be decreased compared to example 1a while retaining acceptable resistivity values.

### Example 2: Further Experiments Using Different Core Particles Dimensions

Further experiments were made to determine that the nanoparticle addition to the aqueous solution of the silicate, i.e. the first coating, provided benefits for a wide range of core particle dimensions (mesh) and apparent density (AD). Experiment parameters and results are presented in table 2 below (heat treatment of 450/650° C. (30/30 min)).

TABLE 2

| | Constitution and | | | | | μ- | | Total core |
|---|---|---|---|---|---|---|---|---|
| Sample | conditions | GS | TRS | d | Res | max | Hc | loss |
| 2-1 | 40 mesh, AD3.0, | 18.3 | 67.6 | 7.53 | 696 | 631 | 124 | 104 |
| | 0.05 wt % silicate | | | | | | | |
| | with β/α = 3.2, 20 | | | | | | | |
| | mol % Y₂O₃ + 0.04 | | | | | | | |
| | wt % Bi(OH)₃ | | | | | | | |
| 2-2 | 40 mesh AD3.4, | 9.0 | 50.0 | 7.51 | 7324 | 651 | 108 | 84 |
| | 0.1 wt % silicate | | | | | | | |
| | with β/α = 3.2, 15 | | | | | | | |
| | mol % Y₂O₃ + 0.1 | | | | | | | |
| | wt % Bi₂O₃ | | | | | | | |
| 2-3 | As sample 2-1 but | 24.3 | 71.9 | 7.41 | 1719 | 375 | 181 | 105 |
| | 100 mesh, AD3.0, | | | | | | | |
| | 0.2 wt % silicate | | | | | | | |
| | with β/α = 3.2, 20 | | | | | | | |
| | mol % Y₂O₃ + 0.08 | | | | | | | |
| | wt % Bi(OH)₃ | | | | | | | |
| 2-4 | As sample 2-3 but | 23.4 | 67.3 | 7.40 | 5874 | 320 | 180 | 107 |
| | 0.3 wt % silicate | | | | | | | |
| 2-5 | As sample 2-3 but | 14.8 | 59.0 | 7.42 | 12600 | 341 | 170 | 99 |
| | AD3.2 | | | | | | | |
| 2-6 | As sample 2-5 but | 13.8 | 66.0 | 7.39 | 16630 | 322 | 166 | 99 |
| | 0.25 wt % 1146 | | | | | | | |
| | silane instead of | | | | | | | |
| | 0.15 wt % | | | | | | | |
| 2-7 | As sample 2-5 but | 16.0 | 56.7 | 7.41 | 20497 | 308 | 168 | 100 |
| | 0.3 wt % silicate | | | | | | | |
| | and 30 mol % Y₂O₃ | | | | | | | |
| 2-8 | As sample 2-3 but | 10.5 | 53.9 | 7.45 | 30281 | 368 | 137 | 87 |
| | AD3.4 and 10 | | | | | | | |
| | mol % Y₂O₃ | | | | | | | |
| 2-9 | 200 mesh, AD3.2, | 13.2 | 67.1 | 7.27 | 34424 | 253 | 231 | 120 |
| | 0.2 wt % silicate, | | | | | | | |
| | 0.16 wt % Bi(OH)₃, | | | | | | | |
| | 20 mol % Y₂O₃, and | | | | | | | |
| | 0.2 wt % 1146 | | | | | | | |
| | silane | | | | | | | |
| 2-10 | As sample 2-9 but | 11.9 | 70.5 | 7.26 | 60691 | 243 | 228 | 120 |
| | 0.3 wt % 1146 | | | | | | | |
| | silane | | | | | | | |

The results thus show that soft magnetic iron-based core particles having different sizes may be efficiently coated with the first and second coatings.

Additionally, the results show that the first and second coatings provide good electrical resistivity for soft magnetic iron-based core particles having different apparent density. The apparent density has a clear effect on mechanical strength and coercivity and thus total core loss.

Additionally, the results show that good results can be obtained for different silicate concentrations in the first coating as well as different silane concentrations in the second coating. The amounts may further be adjusted to optimize both electrical resistivity and permeability.

### Example 3a: Further Experiments Using Different Types of Nanoparticles

Further experiments were made to determine whether the Y₂O₃ nanoparticles could be replaced with other nanoparticles while providing the same or similar improvement of the properties of the test part. Experiment parameters and results are presented in table 3a below (heat treatment of 450/650° C. (30/30 min)). Three series of tests were made corresponding to three reference samples (ref1, ref2, ref3). Due to unavoidable variations between test series, the properties determined for each sample are only fully comparable to those of other samples having the same reference, i.e. belonging to the same test series. Comparison between samples from different test series is still possible. The AD of the soft magnetic iron-based core particles used was 3.35 g/cm³ unless specified.

TABLE 3a

| | Constitution | | | | | | | | | Total |
|---|---|---|---|---|---|---|---|---|---|---|
| | and | | | | | | | μ- | | core |
| Sample | conditions | GS | TRS | d | Res | B4 | B10 | max | Hc | loss |
| 3-1 | ref1: 0.1 | 9.1 | 58 | 7.46 | 9072 | 1.3 | 1.57 | 477 | 138.2 | 79.9 |
| (same as | wt % Bi₂O₃ + | | | | | | | | | |
| 1-5) | 20 mol % | | | | | | | | | |
| | Y₂O₃, | | | | | | | | | |
| | AD3.32 | | | | | | | | | |
| 3-2 | ref2: 0.08 | 9.6 | 56.2 | 7.46 | 13253 | 1.30 | 1.57 | 475 | 138.9 | 79.4 |
| (same as | wt % Bi(OH)₃ + | | | | | | | | | |
| 1-6) | 20 mol % | | | | | | | | | |
| | Y₂O₃ | | | | | | | | | |
| 3-3 | ref3: 0.08 | 9.0 | 60 | 7.49 | 17422 | 1.32 | 1.58 | 504 | 134.5 | 78.1 |
| | wt % Bi(OH)₃ + | | | | | | | | | |
| | 20 mol % | | | | | | | | | |
| | Y₂O₃ | | | | | | | | | |

ZrO₂ replacing Y₂O₃

| | | | | | | | | | | |
|---|---|---|---|---|---|---|---|---|---|---|
| 3-4 | As ref3 but | 9.0 | 57 | 7.49 | 1844 | 1.33 | 1.59 | 525 | 131.4 | 76.1 |
| | 1 mol % | | | | | | | | | |
| | ZrO₂ | | | | | | | | | |
| | instead of | | | | | | | | | |
| | 20 mol % | | | | | | | | | |
| | Y₂O₃ | | | | | | | | | |
| 3-5 | As ref3 but | 9.0 | 68 | 7.48 | 8333 | 1.32 | 1.58 | 502 | 133.3 | 76.7 |
| | 2.5 mol % | | | | | | | | | |
| | ZrO₂ | | | | | | | | | |
| | instead of | | | | | | | | | |
| | 20 mol % | | | | | | | | | |
| | Y₂O₃ | | | | | | | | | |
| 3-6 | As ref2 but | 9.2 | 60 | 7.47 | 4053 | 1.32 | 1.58 | 510 | 135.2 | 77.9 |
| | 5 mol % | | | | | | | | | |
| | ZrO₂ | | | | | | | | | |
| | instead of | | | | | | | | | |
| | 20 mol % | | | | | | | | | |
| | Y₂O₃ | | | | | | | | | |
| 3-7 | As ref2 but | 9.1 | 58 | 7.46 | 2080 | 1.32 | 1.58 | 526 | 133.8 | 78.0 |
| | 10 mol % | | | | | | | | | |
| | ZrO₂ | | | | | | | | | |
| | instead of | | | | | | | | | |
| | 20 mol % | | | | | | | | | |
| | Y₂O₃ | | | | | | | | | |
| 3-8 | As ref1 but | 9.0 | 54 | 7.47 | 905 | 1.36 | 1.60 | 641 | 133.3 | 78.4 |
| | 10 mol % | | | | | | | | | |
| | ZrO₂ | | | | | | | | | |
| | instead of | | | | | | | | | |
| | 20 mol % | | | | | | | | | |
| | Y₂O₃ | | | | | | | | | |
| 3-9 | As ref1 but | 10.0 | 55 | 7.48 | 499 | 1.37 | 1.60 | 655 | 134.0 | 78.8 |
| | 20 mol % | | | | | | | | | |
| | ZrO₂ | | | | | | | | | |
| | instead of | | | | | | | | | |
| | 20 mol % | | | | | | | | | |
| | Y₂O₃ | | | | | | | | | |

Mg(OH)₂ replacing Y₂O₃

| | | | | | | | | | | |
|---|---|---|---|---|---|---|---|---|---|---|
| 3-10 | As ref2 but | 11.7 | 67 | 7.48 | 3643 | 1.33 | 1.59 | 551 | 134.7 | 78.5 |
| | 10 mol % | | | | | | | | | |
| | Mg(OH)₂ | | | | | | | | | |
| | instead of | | | | | | | | | |
| | 20 mol % | | | | | | | | | |
| | Y₂O₃ | | | | | | | | | |
| 3-11 | As ref1 but | 8.4 | 51 | 7.46 | 4154 | 1.32 | 1.58 | 514 | 133.6 | 77.9 |
| | 10 mol % | | | | | | | | | |
| | Mg(OH)₂ | | | | | | | | | |
| | instead of | | | | | | | | | |
| | 20 mol % | | | | | | | | | |
| | Y₂O₃, and | | | | | | | | | |
| | AD3.34 | | | | | | | | | |
| 3-12 | As ref1 but | 9.1 | 55 | 7.46 | 5760 | 1.32 | 1.58 | 518 | 135.6 | 78.4 |
| | 20 mol % | | | | | | | | | |
| | Mg(OH)₂ | | | | | | | | | |
| | instead of | | | | | | | | | |
| | 20 mol % | | | | | | | | | |
| | Y₂O₃, and | | | | | | | | | |
| | AD3.34 | | | | | | | | | |

CaCO₃ replacing Y₂O₃

| | | | | | | | | | | |
|---|---|---|---|---|---|---|---|---|---|---|
| 3-13 | As ref2 but | 11.3 | 67 | 7.48 | 2536 | 1.33 | 1.59 | 553 | 137.5 | 79.7 |
| | 10 mol % | | | | | | | | | |
| | CaCO₃ | | | | | | | | | |
| | instead of | | | | | | | | | |
| | 20 mol % | | | | | | | | | |
| | Y₂O₃ | | | | | | | | | |

ZnO replacing Y₂O₃

| | | | | | | | | | | |
|---|---|---|---|---|---|---|---|---|---|---|
| 3-14 | As Ref3 but | 9.0 | 60.0 | 7.49 | 7208 | 1.33 | 1.59 | 522 | 132.3 | 76.4 |
| | 2.5 mol % | | | | | | | | | |
| | ZnO instead | | | | | | | | | |
| | of 20 mol % | | | | | | | | | |
| | Y₂O₃ | | | | | | | | | |
| 3-15 | As ref3 but | 9.0 | 64 | 7.48 | 7882 | 1.33 | 1.59 | 531 | 132.9 | 76.6 |
| | 5 mol % ZnO | | | | | | | | | |
| | instead of | | | | | | | | | |
| | 20 mol % | | | | | | | | | |
| | Y₂O₃ | | | | | | | | | |
| 3-16 | As ref1 but | 9.6 | 52 | 7.47 | 3291 | 1.32 | 1.58 | 515 | 134.0 | 77.8 |
| | 10 mol % | | | | | | | | | |
| | ZnO instead | | | | | | | | | |
| | of 20 mol % | | | | | | | | | |
| | Y₂O₃, and | | | | | | | | | |
| | AD3.34 | | | | | | | | | |
| 3-17 | As ref1 but | 9.3 | 55 | 7.47 | 2567 | 1.32 | 1.59 | 522 | 137.7 | 78.6 |
| | 20 mol % | | | | | | | | | |
| | ZnO instead | | | | | | | | | |
| | of 20 mol % | | | | | | | | | |
| | Y₂O₃, and | | | | | | | | | |
| | AD3.34 | | | | | | | | | |

MgO replacing Y₂O₃

| | | | | | | | | | | |
|---|---|---|---|---|---|---|---|---|---|---|
| 3-18 | As ref3 but | 8.0 | 60 | 7.49 | 13568 | 1.32 | 1.58 | 504 | 133.6 | 76.9 |
| | 20 mol % | | | | | | | | | |
| | MgO | | | | | | | | | |
| | instead of | | | | | | | | | |
| | 20 mol % | | | | | | | | | |
| | Y₂O₃ | | | | | | | | | |

TiO₂ replacing Y₂O₃

| | | | | | | | | | | |
|---|---|---|---|---|---|---|---|---|---|---|
| 3-19 | As ref3 but | 9.0 | 65 | 7.49 | 12322 | 1.31 | 1.58 | 494 | 131.9 | 76.8 |
| | 20 mol % | | | | | | | | | |
| | TiO₂ | | | | | | | | | |
| | (anatase) | | | | | | | | | |
| | instead of | | | | | | | | | |
| | 20 mol % | | | | | | | | | |
| | Y₂O₃ | | | | | | | | | |

Al₂O₃ replacing Y₂O₃

| | | | | | | | | | | |
|---|---|---|---|---|---|---|---|---|---|---|
| 3-20 | As ref3 but | 9.0 | 63 | 7.48 | 8737 | 1.32 | 1.59 | 514 | 138.0 | 77.7 |
| | 10 mol % | | | | | | | | | |
| | Al₂O₃ | | | | | | | | | |
| | instead of | | | | | | | | | |
| | 20 mol % | | | | | | | | | |
| | Y₂O₃ | | | | | | | | | |

As seen from the table, also nanoparticles of ZrO₂, Mg(OH)₂, CaCO₃, ZnO, MgO, TiO₂, and Al₂O₃ can be used in the first coating to improve the resistivity. Of these materials, Y₂O₃ nanoparticles however provide the best overall performance for the test parts.

ZrO₂ and ZnO nanoparticles showed increased electrical resistivity for the lower molar concentrations (maximum at 2.5 mol %, and 5 mol % respectively).

### Example 3b: Further Experiments Using Different Nanoparticle Diameters

Further experiments were made to explore the effect of various diameters of the Y₂O₃ nanoparticles. The β/α molar ratio was 3.2. Experiment parameters and results are presented in table 3b below (heat treatment of 450/650° C. (30/30 min)).

TABLE 3b

| | Constitution | | | | | μ- | | Total |
|---|---|---|---|---|---|---|---|---|
| Sample | and conditions | GS | TRS | d | Res | max | Hc | core loss |
| 3-21 | 0.08 wt % | 10.4 | 61.6 | 7.48 | 12526 | 498 | 135 | 10.4 |
| | Bi(OH)₃ + 20 | | | | | | | |
| | mol % Y₂O₃ (US | | | | | | | |
| | Research | | | | | | | |
| | Nanomaterials | | | | | | | |
| | Inc., 99.99% | | | | | | | |
| | Y₂O₃, | | | | | | | |
| | nominally 10 | | | | | | | |
| | nm, (US3552)) | | | | | | | |
| 3-22 | 20 mol % Y₂O₃ | 10.8 | 54.7 | 7.49 | 7699 | 535 | 133 | 10.8 |
| | (SkySpring | | | | | | | |
| | Nanomaterials | | | | | | | |
| | Inc., 99.995% | | | | | | | |
| | Y₂O₃ nominally | | | | | | | |
| | 30-50 nm, | | | | | | | |
| | (8210CG)) | | | | | | | |
| 3-23 | 20 mol % Y₂O₃ | 11.2 | 64.0 | 7.47 | 13519 | 525 | 133 | 11.2 |
| | (SkySpring | | | | | | | |
| | Nanomaterials, | | | | | | | |
| | Inc., 99.995% | | | | | | | |
| | Y₂O₃, | | | | | | | |
| | nominally 0.5- | | | | | | | |
| | 1.0 μm | | | | | | | |
| | (8211CG), | | | | | | | |
| | experimentally | | | | | | | |
| | determined as | | | | | | | |
| | 200 nm) | | | | | | | |

As seen from the table, the nano particles having various sizes work well in the first coating and provide good electrical and magnetic properties. Furthermore, the yttria product specified nominally to 0.5^{~}1.0 μm was experimentally determined by SEM to comprise agglomerates comprising nanoparticles with an average particle size D₅₀ of 200 nm.

### Example 4—Further Experiments Using Different β/α Molar Ratios and Silicate Concentrations

Further experiments were made to explore the effect of various β/α molar ratios (SiO₂K₂O) as well as different concentrations of the silicate in the first coating. Experiment parameters and results are presented in table 4 below (heat treatment at 450/650° C. (30/30 min)). 0.08 wt % Bi(OH)₃ was used in each sample.

TABLE 4

| | Constitution | | | | | | | Total |
|---|---|---|---|---|---|---|---|---|
| Sample | and conditions | GS | TRS | d | Res | μ-max | Hc | core loss |
| 4-1 | Ref: 0.1 | 10.4 | 61.6 | 7.48 | 12526 | 498 | 135 | 83.5 |
| | wt % | | | | | | | |
| | silicate, | | | | | | | |
| | β/α = 3.2, 20 | | | | | | | |
| | mol % Y₂O₃ | | | | | | | |
| 4-2 | 0.1 wt % | 10.5 | 56.6 | 7.47 | 11206 | 501 | 136 | 83.7 |
| | silicate, | | | | | | | |
| | β/α = 2.5, 8 | | | | | | | |
| | mol % Y₂O₃ | | | | | | | |
| 4-3 | 0.1 wt % | 11.0 | 57.3 | 7.48 | 19566 | 509 | 134 | 83.2 |
| | silicate, | | | | | | | |
| | β/α = 2.5, 16 | | | | | | | |
| | mol % Y₂O₃ | | | | | | | |
| 4-4 | 0.1 wt % | 10.9 | 65.0 | 7.46 | 16193 | 482 | 135 | 84.6 |
| | silicate, | | | | | | | |
| | β/α = 2.5, 24 | | | | | | | |
| | mol % Y₂O₃ | | | | | | | |
| 4-5 | 0.2 wt % | 10.5 | 53.9 | 7.45 | 30302 | 368 | 137 | 87.1 |
| | silicate, | | | | | | | |
| | β/α = 3.2, 10 | | | | | | | |
| | mol % Y₂O₃ | | | | | | | |
| 4-6 | 0.2 wt % | 10.8 | 52.2 | 7.44 | 16104 | 344 | 142 | 89.1 |
| | silicate, | | | | | | | |
| | β/α = 3.2, 20 | | | | | | | |
| | mol % Y₂O₃ | | | | | | | |
| 4-7 | 0.2 wt % | 11.0 | 58.0 | 7.45 | 17180 | 355 | 139 | 88.9 |
| | silicate, | | | | | | | |
| | β/α = 3.2, 30 | | | | | | | |
| | mol % Y₂O₃ | | | | | | | |

As seen from the table, a β/α ratio of 2.5 gives slightly better resistivity results. The table further shows that if the wt % of silicate is increased (such as doubled to 0.2 wt %), then the mol % of the Y₂O₃ nanoparticles can be decreased (such as halved to 10 mol %). Note that the total added weight of nanoparticles is the same for the two selected β/α-ratios, i.e., the molar content of nanoparticles versus silicon was kept constant.

### Example 5: Further Experiments Using Different Metal-Organic Compounds for the Second Coating

Further experiments were made to determine the effects of using various metal-organic compounds instead of the standard Dynasylan® 1146 silane for the second coating. Experiment parameters and results are presented in table 5 below (heat treatment of 450/650° C. (30/30 min)).

TABLE 5

| | | | | | | | | | Total | Total |
|---|---|---|---|---|---|---|---|---|---|---|
| | | | | | | | | | core | core |
| | Constitution | | | | | | | | loss at | loss |
| | and | | | | | | μ- | | (1T/ | at (1T/ |
| Sample | conditions | TRS | d | Res | B4 | B10 | max | Hc | 100 Hz) | 1 kHz) |
| 5-1 | Ref (0.15% | 66 | 7.48 | 12166 | 1.31 | 1.57 | 501 | 134 | 6.3 | 82.4 |
| | Dynasylan ® | | | | | | | | | |
| | 1146) | | | | | | | | | |
| 5-2 | 0.15% | 44 | 7.50 | 11231 | 1.31 | 1.58 | 508 | 131 | 6.2 | 82.1 |
| | Dynasylan ® | | | | | | | | | |
| | HYDROSIL | | | | | | | | | |
| | 2776 (water- | | | | | | | | | |
| | borne) | | | | | | | | | |
| 5-3 | 0.30% | 57 | 7.49 | 13549 | 1.32 | 1.58 | 529 | 131 | 6.3 | 82.1 |
| | Dynasylan ® | | | | | | | | | |
| | HYDROSIL | | | | | | | | | |
| | 2776 (water- | | | | | | | | | |
| | borne) | | | | | | | | | |
| 5-4 | 0.15% | 44 | 7.49 | 7296 | 1.30 | 1.58 | 501 | 131 | 6.2 | 82.1 |
| | Dynasylan ® | | | | | | | | | |
| | AMEO | | | | | | | | | |
| | (monomer | | | | | | | | | |
| | with amino- | | | | | | | | | |
| | group) | | | | | | | | | |
| 5-5 | 0.15% | 27 | 7.49 | 188 | 1.29 | 1.58 | 459 | 138 | 6.5 | 91.7 |
| | Dynasylan ® | | | | | | | | | |
| | GLYEO | | | | | | | | | |
| | (monomer | | | | | | | | | |
| | with | | | | | | | | | |
| | glycidyloxy- | | | | | | | | | |
| | group, i.e. no | | | | | | | | | |
| | amino- | | | | | | | | | |
| | functionality) | | | | | | | | | |

As seen from table 5, all metal-organic compounds comprising at least one amino group, i.e. all samples except 7-154, provided good electrical resistivity values and TRS values.

### Example 6—Further Experiments Using Different Lubricants

Further experiments were made to determine the effect of various lubricants on the properties of the test parts. Experiment parameters and results are presented in table 6 below.

TABLE 6

| | Constitution | | | | | | |
|---|---|---|---|---|---|---|---|
| Sample | and conditions | Res | B4 | B10 | μ-max | Hc | Core loss |
| 6-1 (same | Ref2: 0.08 wt % | 13253 | 1.30 | 1.57 | 475 | 138.9 | 79.4 |
| as 1-6) | Bi(OH)₃ + 20 | | | | | | |
| | mol % Y₂O₃ + 0.4 | | | | | | |
| | wt % Amide wax | | | | | | |
| 6-2 | Ref2 with | 11688 | 1.32 | 1.59 | 499 | 138.1 | 78.8 |
| | Intralube ® HD, | | | | | | |
| | Höganäs, | | | | | | |
| | instead of | | | | | | |
| | Amide wax | | | | | | |
| 6-3 | Ref2 with 0.1 | 11984 | 1.31 | 1.58 | 486 | 138.0 | 79.2 |
| | wt % Stearamide + | | | | | | |
| | 0.3% Amide wax | | | | | | |

As seen from the table, the choice of lubricant has only a limited effect on the electric and magnetic properties. Accordingly, different lubricants can be used.

### Example 7a: Further Experiments Using Mixtures of the Ferromagnetic Powder Composition with Other or Further Ferromagnetic Powder Compositions

Further experiments were made to determine whether the ferromagnetic powder composition could be mixed with other ferromagnetic powder composition comprising soft magnetic core particles, in particular alloyed core particles. Such alloyed core particles, by having larger internal resistivity, can provide manufactured parts with lower core loss for high frequency applications, and hence these experiments explored the feasibility of such mixtures and their influence on the properties of manufactured parts. Experiment parameters and results are presented in table 7a below.

TABLE 7a

| | | | | | | Total | Total |
|---|---|---|---|---|---|---|---|
| | | | | | | core | core |
| | | | | | | loss | loss |
| | Constitution | | | | | (0.05T/ | (0.1T/ |
| Sample | and conditions | GS | TRS | Res | B10 | 30 kHz) | 30 kHz) |
| 7-1 | Reference | 7 | 70 | 60700 | 1.38 | 20 | 84 |
| | powder: 200 | | | | | | |
| | mesh core | | | | | | |
| | particles, AD3.2 | | | | | | |
| | with first | | | | | | |
| | coating | | | | | | |
| | comprising 0.2 | | | | | | |
| | wt % silicate + | | | | | | |
| | 20 mol % Y₂O₃ + | | | | | | |
| | 0.16 wt % | | | | | | |
| | Bi(OH)₃, and | | | | | | |
| | second coating | | | | | | |
| | comprising 0.3 | | | | | | |
| | wt % 1146 silane | | | | | | |
| 7-2 | 70 wt % | 9 | 52 | 154000 | 1.37 | 16 | 70 |
| | reference | | | | | | |
| | powder mixed | | | | | | |
| | with 30 wt % | | | | | | |
| | phosphoric acid | | | | | | |
| | treated Fe6.5Si | | | | | | |
| | iron alloy core | | | | | | |
| | particles | | | | | | |
| 7-3 | 70 wt % | 14 | 36 | 107000 | 1.04 | 16 | 70 |
| | reference | | | | | | |
| | powder mixed | | | | | | |
| | with 30 wt % | | | | | | |
| | phosphoric acid | | | | | | |
| | treated typical | | | | | | |
| | Sendust | | | | | | |
| | composition | | | | | | |
| | (FeSiAl, | | | | | | |
| | approx. 9 wt % | | | | | | |
| | Si, 6 wt % Al, Fe | | | | | | |
| | balance) iron | | | | | | |
| | alloy core | | | | | | |
| | particles. | | | | | | |

As seen from the table, the inmixing of the alloyed core particles provided increased resistivity and decreased Total core loss. At the same time, the mechanical strength (TRS) was decreased, however, the TRS remains at more than acceptable levels which is believed to be caused by an increased TRS of the ferromagnetic powder composition compared to prior art ferromagnetic powder compositions with other types of coating. This means that the content of the further ferromagnetic powder composition, i.e. the content of the alloyed core particles, can be increased beyond the tested 30 wt %, such as up to 50 wt % or even up to 60 wt %, and thus provides for manufacturing useable components, due to acceptable mechanical strength, with even lower total core loss at higher frequencies. These advantages are especially useful for passive components (transformers, inductors) made from 200-300 mesh core particles.

### Example 7b: Effects of Thermal Ageing

Further experiments were made to determine the effect of thermal ageing on the properties of the test parts. Experiment parameters and results are presented in table 7b below:

TABLE 7b

| | | Thermal | Total core loss |
|---|---|---|---|
| Sample | Constitution | ageing | change (value) |
| Ref | Reference sample | 5 days | +7% |
| part 1 | manufactured from | at 200 °C | |
| | ferromagnetic powder | | |
| | composition comprising | | |
| | core particles coated using | | |
| | alternative process | | |
| | (phosphoric acid + Bi₂O₃on | | |
| | 40 mesh soft magnetic iron- | | |
| | based core particle) | | |
| Test | Test sample manufactured | 5 days | +1% |
| part 1 | from ferromagnetic powder | at 200 °C | |
| | composition compositing | | |
| | comprising core particles | | |
| | coated using process | | |
| | proposed herein ((silicate + | | |
| | Y₂O₃ nanoparticles + Bi₂O₃) | | |
| | on 40 mesh soft magnetic | | |
| | iron-based core particle) | | |
| Ref | As Ref part 1 but 100 mesh | 5 days | +40% |
| part 2 | soft magnetic iron-based | at 260 °C | |
| | core particles | | |
| Test | As Test part 1 but 100 mesh | 5 days | +5% |
| part 2 | soft magnetic iron-based | at 260 °C | |
| | core particle | | |

As shown in the table the core loss change, i.e. the increase in core loss is smaller for the test parts compared to the reference parts. The ferromagnetic powder composition according to the first aspect of the technology proposed herein therefore, due to the good distribution and high surface coverage of the first coating on the core particles, provides for manufacturing components having improved thermal stability. This is advantageous in applications subjected to high temperatures, i.e. at or above 200° C. such as at 200 to 260° C.

### Example 8: Surface Examination Using SEM/EDS

For this example soft magnetic iron-based core particles were mixed with an aqueous solution of a silicate of the general formula (K₂O)α(SiO2)β at a β/α ratio of 3.1 to 3.4 and at a concentration of 0.1 wt % with or without 20 mol % Y₂O₃ nanoparticles (10 nm) similar to step 1 described above.

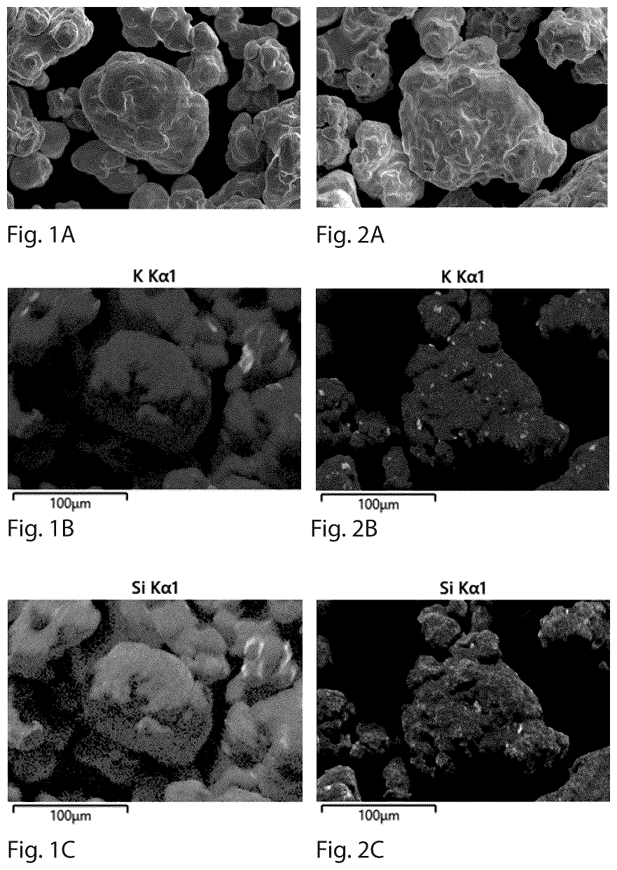

The core particles were examined using a Field Emission Gun Scanning Electron Microscope (FEG-SEM) (Hitachi SU6600) with an Energy Dispersive Spectroscopy detector (Oxford Instruments Ultima Max 65 mm). Measurements were made at a distance of 10 mm (working distance) using an acceleration voltage of 20 kV. The results are shown in in FIGS. 1A-1C and FIGS. 2A-2C and summarized in table 8 further below. Here FIG. 1A shows a SEM image of core particles coated with silicate but without the nanoparticles. In contrast, FIG. 2A shows a SEM image of core particles coated with silicate and nanoparticles. Comparing the images, it can be seen that the core particles in FIG. 2A have a more detailed, i.e., refined, surface structure compared to the core particles in FIG. 1A. This indicates that the first coating is thinner on the core particles in FIG. 2A. FIGS. 1B and 2B show EDS mapping images of the corresponding core particles showing the content of K on the surface in light grey to white. It can further be observed that the first silicate coating differs in thickness over the surface thus forming thicker portions termed patches having a high K content, see FIGS. 1B and 2B, and thinner portions between the patches. As seen in FIG. 2B, there are numerous spatially separated deposits of K on the core particles coated with silicate and nanoparticles compared to only a few larger deposits in FIG. 1B. FIGS. 1C and 2C shows EDS mapping images of the corresponding core particles showing the content of Si on the surface in light grey to white. FIG. 2C shows that the Si content is more evenly distributed with numerous small deposits over the surface of the core particles coated with silicate and nanoparticles compared to the few larger deposits in FIG. 1C.

TABLE 8
EDS point elemental analysis

| | Patches | | | | Between patches | | | |
|---|---|---|---|---|---|---|---|---|
| | | | SiO₂/ | | | | SiO₂/ | |
| | | | K₂O | | | | K₂O | |
| wt % | K | Si | (mol) | Fe | K | Si | (mol) | Fe |
| No nano | 14.4 | 0.56 | 0.11 | 50.7 | 0.17 | 0.48 | 7.9 | 95.5 |
| particles | | | | | | | | |
| 20 mol % | 4.8 | 1.40 | 0.51 | 79.8 | 0.31 | 1.10 | 9.9 | 93.0 |
| Y₂O₃ | | | | | | | | |

As shown in the table, the addition of nanoparticles increases the detected level of Fe in the patches. As the SEM/EDS measurement determines the material content not only on the surface of the particles but also to some extent into the surface (the minimum detection area at 20 kV is about 1.5 μm deep, and about 1 μm in diameter for the EDS point analysis), the increased Fe content (79.8 wt %, bold) detected on the patches for the coating comprising nanoparticles indicates that the patches are thinner and that the silicate coating is distributed more evenly over the surface of the core particles. This is supported by the increased content of silicon (1.10 wt %, bold) measured between the patches for the coating comprising nanoparticles as compared to the sample without nanoparticles (0.48 wt % Si). Also, the Fe-content between patches decreases somewhat (93.0 vs 95.5 wt %) which further indicates a thicker silicate coating. Accordingly, by including the nanoparticles in the first coating the silicate becomes more evenly distributed over the surface of the core particles which correlates with the increased resistivity observed in preceding examples. The increased number of smaller patches on the core particles coated with the silicate coating comprising nanoparticles further improves the particle behaviour during pressing and heat treating of the particles to form parts or components. This is because the distributed patches, which have a relatively high content of potassium, have lubricating properties and thereby can protect the first coating during pressing.

### Example 9: Schematic Cross-Sectional Illustration of the Particles of the Ferromagnetic Powder Composition

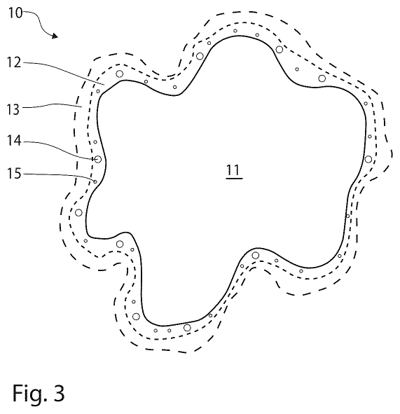

Based on the examples above, FIG. 3 shows a highly schematical cross-sectional illustration of a single particle 10 of a ferromagnetic powder composition according to an embodiment of the first aspect of the technology proposed herein. The particle 10 comprises a soft magnetic iron-based core particle 11 covered by a first coating 12 comprising a silicate. A second coating 13 is also shown and comprises a metal-organic compound. Particles of a compound comprising bismuth and oxygen and having approximate diameters of about 1 μm, one of which is designated the reference numeral 14, are shown dispersed within the first coating 12. Additionally, nanoparticles having an approximate diameter of about 200 nm or less, one of which is designated the reference numeral 15, are also shown dispersed within the first coating 12.

FIG. 3 shows the particle prior to heat treatment, i.e., prior to the ferromagnetic powder being compacted and heat treated to manufacture an object as per the method according to the third aspect of the technology proposed herein. During heat treatment the particles of the compound comprising bismuth and oxygen 14 together with the nanoparticles 15 and the silicate in the first coating 12 and the amino and/or alkyl groups of the metal-organic compound of the second coating 13 are believed to form an evenly distributed bismuth-silicate glass which provides electrical resistivity between the individual particles of the compacted and heat treated ferromagnetic powder composition.

Although FIG. 3 shows the particles of the compound comprising bismuth and oxygen 14 being present in the first coating 12, it is contemplated that the particles of the compound comprising bismuth and oxygen 14 may additionally be dispersed within the second coating 13.

Further, although FIG. 3 shows the first coating 12 and the second coating 13 completely covering the soft magnetic iron-based core particle 11, one or both of these coating may alternatively cover the soft magnetic iron-based core particle 11 only partially.

### Feasible Modifications of the Technology Proposed Herein

The technology proposed herein is not limited to the embodiments described above and shown in the drawings, which primarily have an illustrative and exemplifying purpose. This patent application is intended to cover all adjustments and variants of the preferred embodiments described herein; thus the present invention is defined by the wording of the appended claims and the equivalents thereof. Thus, the equipment may be modified in all kinds of ways within the scope of the appended claims.

Throughout this specification and the claims which follows, unless the context requires otherwise, the word “comprise”, and variations such as “comprises” or “comprising”, will be understood to imply the inclusion of a stated integer or steps or group of integers or steps but not the exclusion of any other integer or step or group of integers or steps.

1. A ferromagnetic powder composition comprising:
(i) soft magnetic iron-based core particles,
(ii) a first coating at least partially covering and being in direct contact with the surface of the core particles, the first coating comprising:
a. a silicate of the general formula (K₂O)α(SiO₂)β, wherein α is moles of K₂O, β is moles of SiO₂, and the β/α molar ratio is in the interval from 0.5 to 4.1,
i. wherein the silicate is present in an amount of 0.02 to 1.0 wt % calculated based on the total weight of the ferromagnetic powder composition,
b. particles of a compound comprising bismuth and oxygen having a D₅₀ measured according to SS-ISO 13320-1 in the interval of 0.1 to 10 μm, and
c. nanoparticles having a D₅₀ measured according to SS-ISO 13320-1 of 10-200 nm.

2. The ferromagnetic powder composition according to claim 1, wherein the nanoparticles are selected from the group consisting of Y₂O₃ nanoparticles, ZrO₂ nanoparticles, ZnO nanoparticles, MgOH₂ nanoparticles, MgO nanoparticles, CaCO₃ nanoparticles, Al₂O₃ nanoparticles, SiO₂ nanoparticles, and TiO₂ nanoparticles.

3. The ferromagnetic powder composition according to claim 1, wherein the content of nanoparticles in the first coating is 1-30 mol %, based on the molar content of potassium K in the first coating.

4. The ferromagnetic powder composition according to claim 1, wherein the nanoparticles have a D₅₀ measured according to SS-ISO 13320-1 of 10-100 nm.

5. The ferromagnetic powder composition according to claim 1, wherein the first coating comprises:
10-25 mol % Y₂O₃ nanoparticles based on the content of K in the first coating, or
1-20 mol % ZrO₂ nanoparticles based on the content of K in the first coating, or
1-20 mol % MgOH₂ nanoparticles based on the content of K in the first coating, or
1-20 mol % CaCO₃ nanoparticles based on the content of K in the first coating, or
1-20 mol % ZnO nanoparticles based on the content of K in the first coating, or
1-30 mol % MgO nanoparticles based on the content of K in the first coating, or
1-30 mol % TiO₂ nanoparticles based on the content of K in the first coating, or
1-20 mol % Al₂O₃ nanoparticles based on the content of K in the first coating, or
1-20 mol % ZnO nanoparticles based on the content of K in the first coating.

6. The ferromagnetic powder composition according to claim 1, wherein the content of the particles of the compound comprising bismuth and oxygen in the first coating is 0.025-0.3 wt %, based on the total weight of the ferromagnetic powder composition.

7. The ferromagnetic powder composition according to claim 1, wherein the compound comprising bismuth and oxygen is selected from the group consisting of bismuth(III) oxide (Bi₂O₃) and bismuth(II) hydroxide (Bi(OH)₃).

8. The ferromagnetic powder composition according to claim 1, further comprising:
(iii) a second coating at least partially covering the surface of the core particles and/or the first coating, the second coating comprising:
a. at least one metal-organic compound having the general formula 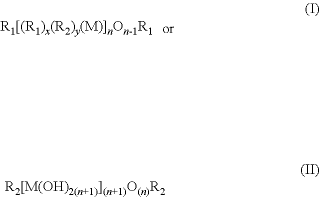
wherein M is selected from the group consisting of Si, Ti, Al, and Zr; O is oxygen;
R₁ is a hydrolysable group; R₂ is an organic moiety and wherein at least one R₂ contains at least one amino group; wherein n is the number of repeating units being an integer between 1 and 20; wherein x is 0 or 1; and wherein y is 1 or 2, and x+y is 2,
wherein the content of the at least one metal-organic compound is 0.05 to 0.40 wt %, based on the total weight of the ferromagnetic powder composition.

9. The ferromagnetic powder composition according to claim 1, further comprising a lubricant.

10. A ferromagnetic powder mixture comprising:
the ferromagnetic powder composition according to claim 1, and
a further ferromagnetic powder composition,
wherein the further ferromagnetic powder composition comprises soft magnetic iron-based core particles that are different from the soft magnetic iron-based core particles of the ferromagnetic powder composition.

11. A method of producing a ferromagnetic powder composition comprising the steps of:
(i) providing soft magnetic iron-based core particles,
(ii) contacting the soft magnetic iron-based core particles with a first aqueous solution comprising:
a. a silicate of the general formula (K₂O)α(SiO₂)β, wherein α is moles of K₂O, β is moles of SiO₂, and the β/α molar ratio is in the interval from 0.5 to 4.1,
i. wherein the silicate is present in an amount of 0.02 to 1.0 wt % calculated based on the total weight of the ferromagnetic powder composition,
b. particles of a compound comprising bismuth and oxygen having a D₅₀ measured according to SS-ISO 13320-1 in the interval of 0.1 to 10 μm, and
c. nanoparticles having a D₅₀ measured according to SS-ISO 13320-1 of 10-200 nm.

12. The method according to claim 11, further comprising one or more of the steps of:
(i) drying the soft magnetic iron-based core particles, and/or
(ii) contacting the soft magnetic iron-based core particles with at least one metal-organic compound having the general formula 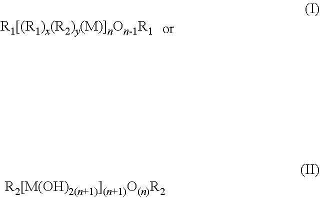
wherein M is selected from the group consisting of Si, Ti, Al, and Zr; O is oxygen; R₁ is a hydrolysable group; R₂ is an organic moiety and wherein at least one R₂ contains at least one amino group; wherein n is the number of repeating units being an integer between 1 and 20; wherein x is 0 or 1; and wherein y is 1 or 2, and x+y is 2,
wherein the content of the at least one metal-organic compound is 0.05 to 0.40 wt %, based on the total weight of the ferromagnetic powder composition, and/or
(iii) mixing the soft magnetic iron-based core particles with a lubricant.

13. A method of manufacturing an object from the ferromagnetic powder composition according to claim 1, comprising the steps of:
(i) compacting the ferromagnetic powder composition in a die at a compaction pressure in the range of 300-2000 MPa, to obtain a compacted part, and
(ii) heat treating the compacted part in a nonreducing atmosphere at a temperature in the range 300-800° C. to obtain the object.

14. An object obtained by the method according to claim 13.

15. An object comprising a compacted ferromagnetic powder composition according to claim 1.
